(19) United States
(12) Patent Application Publication
(10) Pub. No.: US 2015/0172474 A1
(43) Pub. Date: Jun. 18, 2015

(54) FACSIMILE APPARATUS, METHOD OF CONTROLLING THE SAME, AND STORAGE MEDIUM

(71) Applicant: CANON KABUSHIKI KAISHA, Tokyo (JP)

(72) Inventor: Kazuhiro Uruma, Yokohama-shi (JP)

(21) Appl. No.: 14/550,132

(22) Filed: Nov. 21, 2014

(30) Foreign Application Priority Data
Dec. 17, 2013 (JP) 2013-260662

(51) Int. Cl. H04N 1/00; H04N 1/21; H04N 1/047; H04N 1/04

(52) U.S. Cl. CPC H04N 1/001; H04N 1/04; H04N 1/2104; H04N 1/047

(57) ABSTRACT

The facsimile apparatus executes image processing on image data of a read in original in accordance with a capability of a partner apparatus to which the image data is transmitted, transmits the image data for which the image processing is executed to the partner apparatus as transmission data, and saves, to a storage unit, the transmitted transmission data as is.

### BACKGROUND OF THE INVENTION

1. Field of the Invention

The present invention relates to a facsimile apparatus, which is capable of saving a transmission image that is actually transmitted, a method of controlling the same, and a storage medium.

2. Description of the Related Art

Amongst facsimile apparatuses, there are those that have a function for displaying a preview prior to transmission in order that the transmission image can be confirmed. Also, there are those that have a function for printing a transmission image having added it to a transmission result report. Also, it is possible to manage a usage history of who outputted or transmitted what kind of document where. However, in multiple cases described above, the image that is output (preview display, printing, or the like) is an image for the point in time that an original is read in by a reading apparatus at the time of a facsimile transmission, and is different to the transmission image that is actually transmitted to a facsimile apparatus which is a transmission destination.

At the time of the facsimile transmission, a resolution and a paper size are determined in accordance with capability information of the apparatus which is the transmission partner, and the transmission image is converted in accordance with the determined resolution and paper size. For this reason, even if a transmission original size is A3, a transmission image that is reduced to A4, B4, or the like, in accordance with the capabilities of the transmission partner is transmitted to the transmission destination. Similarly, even if a read resolution of the transmission original is U-FINE (16*15.4 line/mm), it is converted to a lower resolution such as STD (8*3.85 line/mm), FINE (8*7.7 line/mm), or the like, in accordance with the capabilities of the transmission partner. For this reason, characters of the transmission original become difficult to read on the receiving side due to image quality degradation from the above described resolution conversion and image reduction from the paper size modification.

In addition, at the time of transmission, the transmission image is transmitted to the transmission destination facsimile apparatus having had a transmission source recording (a header) added to an upper part of the image of the transmission original. The above described transmission source recording is information generated and added for each page that is transmitted, and a transmission date and time in the transmission source recording differs for each page. As described above, there is a difference between the transmission original and the image that is actually transmitted to the transmission destination facsimile apparatus, and it was not possible to confirm the image sent to the transmission destination the facsimile apparatus by the conventional approaches.

In Japanese Patent Laid-Open No. 2006-041716, a technique has been proposed in which, upon a facsimile transmission, the transmission original read in at the reading apparatus and the receiving side resolution information upon transmission are saved, and the image saved at the transmitting side facsimile apparatus is output at the saved resolution.

However, there is a problem with the above described conventional technique as recited below. For example, in the above described conventional technique, upon the facsimile transmission, it is not the image that is actually transmitted itself that is saved. Also, in the above described conventional technique, because the paper size information of the receiving side is not saved, even in a case where a paper size conversion occurs and an image reduction occurs due to the negotiation between the partner side in the facsimile communication and the apparatus, it cannot be confirmed from the transmission image. Also, with the above described conventional technique, because the transmission source recording added in the facsimile transmission is not saved, it cannot be confirmed from the transmission image when it was that the transmission image was transmitted.

### SUMMARY OF THE INVENTION

The present invention enables realization of an arrangement in which image data that is actually transmitted is saved in a facsimile transmission.

One aspect of the present invention provides a facsimile apparatus comprising: a reading unit configured to read an original; an image processing unit configured to execute image processing on image data of the original read by the reading unit in accordance with a capability of a partner apparatus to which the image data is transmitted; a transmission unit configured to transmit the image data for which the image processing is executed by the image processing unit to the partner apparatus as transmission data; and a save unit configured to save, to a storage unit, the transmission data, transmitted by the transmission unit, as is.

Another aspect of the present invention provides a method of controlling a facsimile apparatus, the method comprising: reading an original; executing image processing on image data of the original read in the reading in accordance with a capability of a partner apparatus to which the image data is transmitted; transmitting the image data for which the image processing is executed in the executing to the partner apparatus as transmission data; and saving, to a storage unit, the transmission data, transmitted in the transmitting, as is.

Still another aspect of the present invention provides a non-transitory computer-readable storage medium storing a program for causing a computer to function as the facsimile apparatus.

Further features of the present invention will be apparent from the following description of exemplary embodiments with reference to the attached drawings.

### BRIEF DESCRIPTION OF THE DRAWINGS

FIG. 1 is a block diagram of a facsimile communication apparatus according to the present invention.

FIG. 2 is a software configuration diagram of a facsimile control unit according to the present invention.

FIG. 3 is a configuration diagram for illustrating transmission image setting information for when a facsimile transmission is performed.

FIG. 4 is a view for showing an example of a transmission image that includes recording information of a transmission source for when a facsimile transmission is performed.

FIG. 5 is a view for showing an example of a general facsimile communication procedure.

FIG. 6 is a view for showing an example of a screen on which transmission document save setting is performed by a user mode.

FIG. 7 is an image save flowchart according to a first embodiment.

FIG. 8 is a temporary image save flowchart according to a second embodiment.

FIG. 9 is an image save flowchart according to the second embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Facsimile Apparatus Configuration

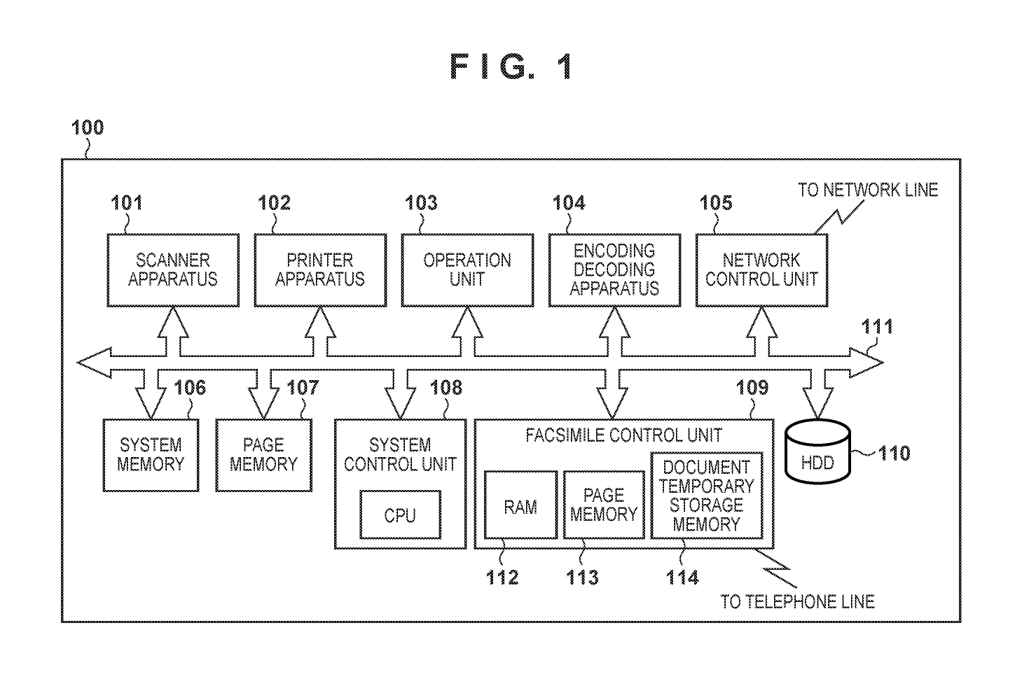

Below, with reference to FIG. 1 through FIG. 7, explanation will be given for a first embodiment of the present invention. Firstly, explanation will be given for a configuration of an image forming apparatus (a facsimile apparatus) in which a facsimile transmission function is embedded in the present invention with reference to FIG. 1.

A facsimile apparatus 100 is provided with a scanner apparatus 101, a printer apparatus 102, an operation unit 103, an encoding decoding apparatus 104, a network control unit 105, a system memory 106, a page memory 107, a system control unit 108, a facsimile control unit 109, and an HDD (storage unit) 110. The scanner apparatus 101 is a reading apparatus that scans an original in a designated mode (for example, paper size, resolution, density, or the like). The printer apparatus 102 is a print apparatus that outputs documents to be printed to a paper output tray via a paper discharging apparatus such as a finisher.

The operation unit 103 is equipped with a display apparatus for displaying an operational state of the apparatus when a user performs various setting operations. The encoding decoding apparatus 104 performs data compression by encoding image information to be transmitted into data. On the other hand, it decodes received compressed data, restoring it to the original image information. The network control unit 105 connects to a LAN, and perform input and output of information with other devices in a network environment.

The system memory 106 comprises a RAM unit and a ROM unit, and it stores information that is registered in the apparatus in advance. Regarding the page memory 107, image information for one page when encoding/decoding is performed is loaded into it.

The system control unit 108 is a microcomputer, including a CPU, for monitoring/controlling various control units, apparatuses, HDDs (hard disk drives), or the like, within the block diagram. Via a system bus 111, each apparatus is connected. The facsimile control unit 109 is connected to a facsimile line such as a PSTN line, and via the PSTN line it is able to communicate with other facsimile apparatuses. The HDD (hard disk) 110 comprises a non-volatile memory, and stores received documents, scanned documents, or the like.

The facsimile control unit 109 is provided with a RAM 112, a page memory 113, and a document temporary storage memory (temporary storage unit) 114. The RAM 112 temporarily saves information of a transmission original for when a facsimile transmission is performed, partner device capability information of which is notified by a facsimile procedure signal DIS, and negotiation information determined from the above described information of the transmission original and the capability information of the partner apparatus. The page memory 113 is a memory for storing a transmission image (transmission data) for one page to be transmitted to a transmission destination facsimile apparatus when a facsimile transmission is performed. In the above described page memory 113 an image itself, which is transmitted to the transmission destination facsimile apparatus, is actually stored. The document temporary storage memory 114 is a memory for storing a transmission image, for a single document, which is to be transmitted to the transmission destination facsimile apparatus when the facsimile transmission is performed. In the document temporary storage memory 114 an image itself, which is actually to be transmitted to the facsimile apparatus which is the transmission destination, is stored. Also, processing for storing a transmission image into the document temporary storage memory 114 can be performed at a higher speed than in the case of storing the transmission image into the HDD 110. This is because, as shown in FIG. 1, the document temporary storage memory 114 is arranged in the facsimile control unit 109, and it is clear that a transmission image can be stored at a higher speed than with the HDD 110, which is arranged externally to the facsimile control unit 109.

<Facsimile Control Unit Control Configuration>

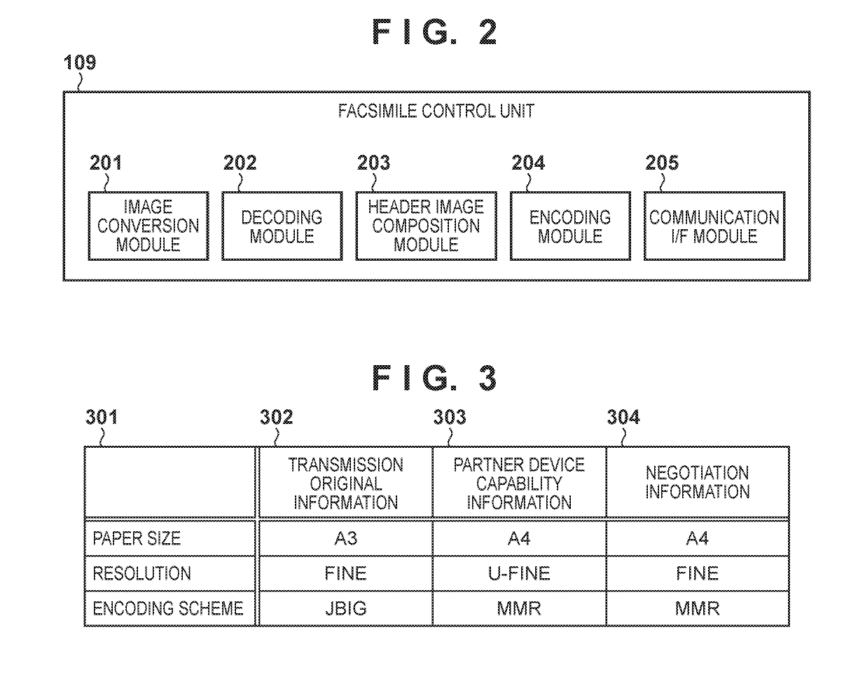

Next, with reference to FIG. 2, explanation will be given for a control configuration within the facsimile control unit 109 in the present invention. As illustrated in FIG. 2, the facsimile control unit 109 is provided with an image conversion module 201, a decoding module 202, a header image composition module 203, an encoding module 204, and a communication I/F module 205.

The image conversion module 201 performs image conversion of a transmission image read from an original by the scanner apparatus 101 into an optimal paper size and resolution in accordance with the above described negotiation information. The decoding module 202 restores a transmission image for which image conversion is performed in the image conversion module 201 into original image information. The header image composition module 203 performs image composition of a transmission source recording (header) with an upper part of image information restored by the decoding module 202 The encoding module 204 re-encodes image information in which the transmission source recording is added by the header image composition module 203 in accordance with the above described negotiation information. The communication I/F (interface) module 205 transmits the above described re-encoded transmission image to the transmission destination facsimile apparatus via the PSTN line. Note, the image conversion module 201, the decoding module 202, the image composition unit 203, and the encoding module 204 function as an image processing unit.

<Transmission Image Setting Information>

Next, with reference to FIG. 3, explanation will be given for setting information 301 which is for a transmission image that is transmitted upon a facsimile transmission, and which is held in the RAM 112 within the facsimile control unit 109 in the present invention. As shown in FIG. 3, in the setting information 301, in each of transmission original information 302, partner device capability information 303, and negotiation information 304, a paper size, a resolution, and information of an encoding scheme (parameters) are defined. Note, the parameters shown here are only one example, and at least one of the above described parameters and other parameters may be included.

In the transmission original information 302, a paper size, a resolution, and an encoding scheme of a transmission original read in by the scanner apparatus 101 are stored. In the partner device capability information 303, capability information of a transmission destination, of which notification is made from a transmission destination facsimile apparatus (partner apparatus) using a facsimile procedure signal DIS, is stored. In other words, a paper size that is printable by the partner apparatus, a resolution that is printable by the partner apparatus, and a printing encoding scheme that is processable by the partner apparatus are stored. In the negotiation information 304 the paper size, the resolution, and the encoding scheme for which the image data is actually transmitted, which are determined from the above described the transmission original information 302 and the partner device capability information 303, are stored. In other words, the above described negotiation information 304 is used for the paper size, the resolution, and the encoding scheme upon a facsimile procedure signal DCS output.

<Transmission Image>

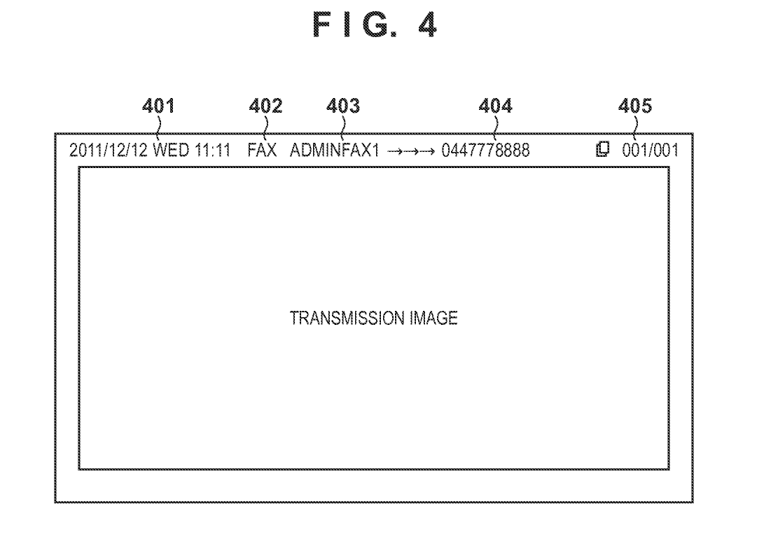

Next, with reference to FIG. 4, explanation will be given for an example of a transmission image with an added transmission source recording (header) in a facsimile transmission. A transmission source recording comprises a transmission date and time 401, a FAX mark 402 which is a fax transmission symbol, transmission source information 403 which indicates telephone number information of a transmission source or abbreviated name information, transmission destination information 404 which indicates telephone number information of a transmission destination or abbreviated name information, and page information 405. The above described transmission source recording is generated by the header image composition module 203 prior to transmission of one page, and added to an upper part of image information of the transmission image.

<Facsimile Communication Procedure>

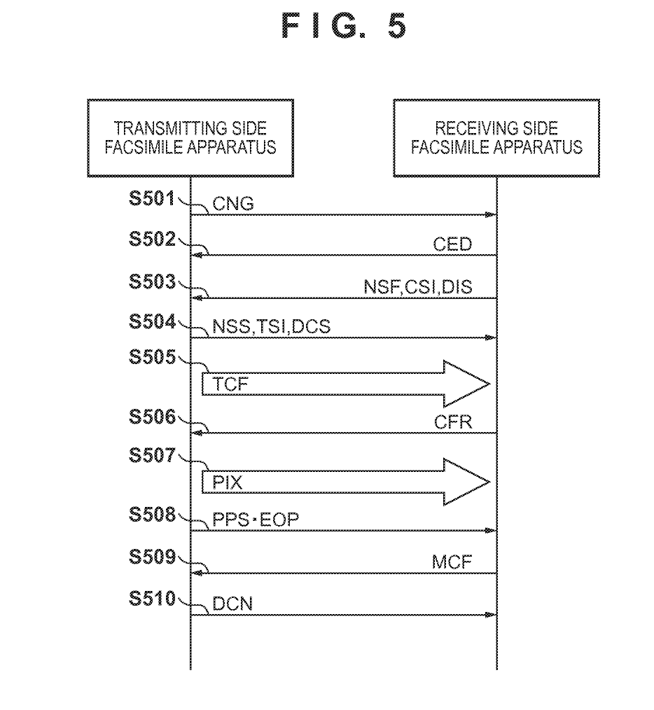

Next, with reference to FIG. 5, explanation will be given for a general facsimile communication procedure. Here, explanation will be given for a facsimile transmission operation on a transmitting side. In step S501, a transmitting side facsimile apparatus transmits a CNG signal of 1100 Hz to a receiving side facsimile apparatus. Upon the above mentioned facsimile transmission initiation, the facsimile control unit 109 stores information of a transmission original read into the RAM 112 by the scanner apparatus 101 as the transmission original information 302.

Next, in step S502, the receiving side facsimile apparatus transmits a CED signal of 2100 Hz to the transmitting side facsimile apparatus. In step S503, the receiving side facsimile apparatus transmits NSF, CSI, and DIS signals, which are facsimile procedure signals, to the transmitting side facsimile apparatus. Here, the facsimile control unit 109 in the transmitting side facsimile apparatus stores information of the paper size, the resolution, and the encoding scheme into the RAM 112 as the partner device capability information 303 upon reception of the above described DIS signal. Note, the NSF signal indicates a non-standard function identification signal. The CSI signal indicates a registered telephone number of the receiver side. The DIS signal indicates various functional information that the receiving side has.

Next, in step S504, the transmitting side facsimile apparatus transmits NSS, TSI, and DCS signals, which are facsimile procedure signals, to the receiving side facsimile apparatus when the above described NSF, CSI, and DIS signals are received. Here, the facsimile control unit 109 in the transmitting side facsimile apparatus determines information of the optimal paper size, resolution, and encoding scheme from the partner device capability information and the original document information received by the above described DIS signal, and stores this as the negotiation information 304 into the RAM 112. Note, the NSS signal indicates a non-standard function setting signal. The TSI signal indicates a registered telephone number of the transmitter side. The DCS signal indicates a transmission condition from the transmitter.

Next, in step S505, the transmitting side facsimile apparatus transmits a TCF (training check) signal, which is dummy image data, to the receiving side facsimile apparatus. Continuing on, in step S506, the receiving side facsimile apparatus, in a case where the TCF data could be received normally, transmits a facsimile procedure signal (CFR signal) to the transmitting side facsimile apparatus. Here, the receiving side facsimile apparatus is in a state in which it waits to receive image data.

Next, in step S507, when the transmitting side facsimile apparatus receives the above described CFR signal, it enters into an image transmission phase, and transmits image data, which is encoding compression data (PIX), to the receiving side facsimile apparatus. More specifically, upon transmission of the above described image data, the image conversion module 201 in the facsimile control unit 109 first executes a paper size conversion and a resolution conversion in accordance with the above described negotiation information for the transmission image read by the scanner apparatus 101. Continuing on, the decoding module 202 restores the above described transmission image upon which the image conversion was performed into the original image information. The header image composition module 203 adds the transmission source recording (header) to the upper part of the above described image information. The encoding module 204 encodes the image information to which the transmission source recording is added in accordance with the negotiation information 304, thereby generating the transmission image. After this, the communication I/F module 205 transmits the generated the transmission image to the receiving side facsimile apparatus.

Next, in step S508, the transmitting side facsimile apparatus transmits a PPS-EOP signal indicating that the image data is of the last page to the receiving side facsimile apparatus. Also, in a case where the image data is not of the last page, a PPS-EOM signal or a PPS-MPS signal is transmitted. In step S509, the receiving side facsimile apparatus transmits to the transmitting side facsimile apparatus an MCF signal that indicates that the image data sent from the transmitting side facsimile apparatus could be received normally. Also, in a case of multiple pages, the above described step S507-step S509 is repeated for each page.

In step S510, the transmitting side facsimile apparatus transmits a DCN signal which indicates the end of the communication to the receiving side facsimile apparatus, and the facsimile communication ends. Then, similarly, the receiving side facsimile apparatus receives the DCN signal, and ends the facsimile communication.

<Setting Screens>

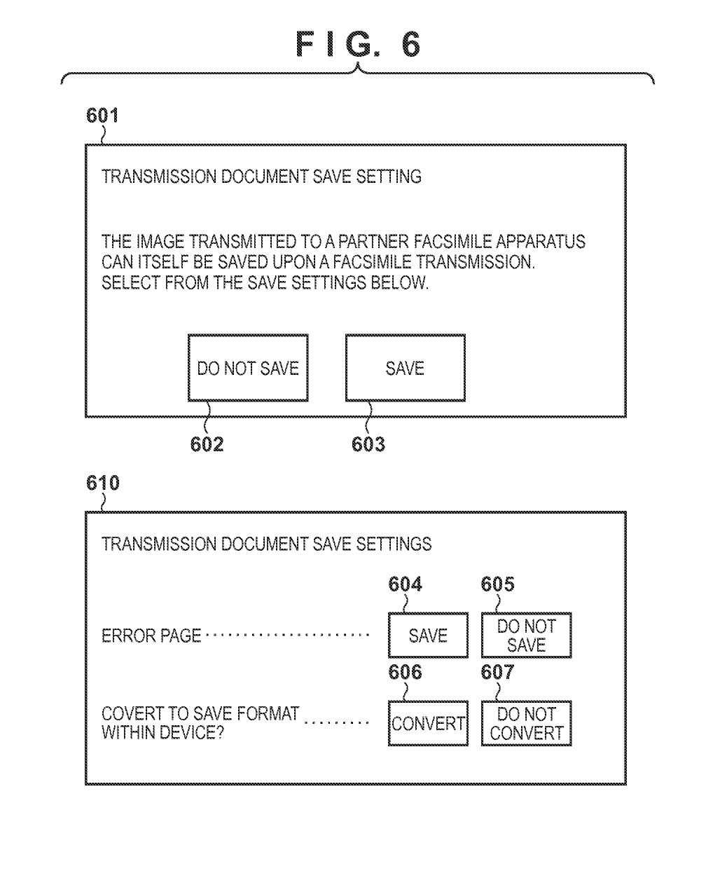

Next, with reference to FIG. 6, explanation will be given for setting screens in a user mode that a user can set by the operation unit 103 in the present invention. A setting screen 601 is a screen for a transmission document save setting within the user mode, and it can be set whether or not to save the transmission image itself upon a facsimile transmission. The setting screen 601 is held in a power disconnection retention capable RAM unit in the system memory 106. In the above described setting screen 601, when do not save 602 is selected, the facsimile transmission image is not saved. Also, when save 603 is selected, transition is made to a setting screen 610, by which detailed setting is possible.

In the setting screen 610, when save 604 error page (error data) is selected, pages for which a transmission errors occur are also saved in addition to transmission images that are transmitted normally. Also, when do not save 605 is selected, only transmission images that are transmitted normally are saved. Furthermore, it is possible that the encoding scheme is modified in accordance with the save format within the transmitter device, and that the transmission image is saved in an encoding scheme that is not the encoding scheme of the transmission image of which the facsimile transmission is actually performed.

When convert 606 to the save format within the device is selected, the save format within the device information is stored in the RAM unit inside the system memory 106. Then, saving is performed by converting the encoding scheme of the transmission image, of which the facsimile transmission is actually performed, into the encoding scheme of the save format within the device. For example, in a case where the encoding scheme of the transmission image of which the facsimile transmission is actually performed is MMR, and the save format within the device is band JBIG, it becomes possible to decode the above described MMR transmission image, encode into band JBIG and save. Also, if do not convert 607 into the save format within the device is selected, a save is performed in the encoding scheme for transmission image of which the facsimile transmission is actually performed itself.

<Processing Procedure>

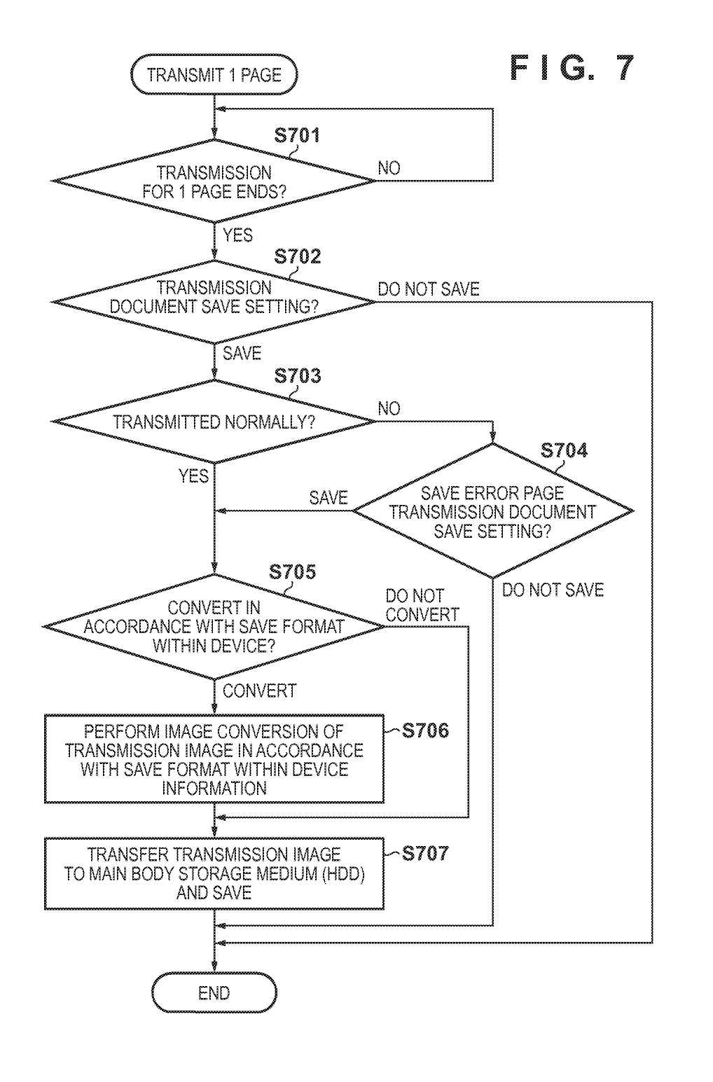

Next, with reference to FIG. 7, explanation will be given for details of a processing procedure in the first embodiment. Here, explanation will be given for an operation in which, in a facsimile transmission, for each transmission completion for a page, the transmission image of which the facsimile transmission is actually performed is saved in the transmission source facsimile apparatus. Note, the processing explained below is realized by the CPU of the system control unit 108 executing a control program stored in a memory.

In step S701, the facsimile control unit 109, controlled by the CPU of the system control unit 108, determines whether or not the transmission of the transmission image for one page has ended. This determination is performed at the timing of step S509 of FIG. 5. Regarding the above described completion of the transmission image for one page, the transmission of one page is determined to have ended when, in response to a PPS-EOP, PPS-EOM, or PPS-MPS, or a EOP, EOM, or MPS facsimile procedure signal transmitted from the transmitting side facsimile apparatus, an MCF, RTP, or RTN is received. Also, upon reception of a DCN, which is a disconnection signal from the receiving side, or in a case where there is no notification of a facsimile procedure signal within a predetermined period from the receiving side, it is determined that the transmission of the page ended in an error. When it is determined that the transmission of the page ends, transition is made to step S702. If not, the determination of step S701 is repeated at regular intervals.

Next, in step S702, the facsimile control unit 109 acquires information that the user sets via the setting screen 601 from the RAM unit within the system memory 106. In a case where the setting of the above described setting screen 601 is the “save” setting, transition is made to step S703. In a case where the setting is “do not save”, the processing ends.

In a case where the transmission document is saved, the facsimile control unit 109, in step S703, determines whether or not the page is transmitted normally. In a case where it is transmitted normally, transition is made to step S705, and if not, transition be made to step S704. More specifically, in a case where, in step S509 described above, an MCF signal is received, it is determined that yes, the page is transmitted normally, and transition is made to step S705. In a case other than the MCF signal, transition is made to step S704. In step S704, the facsimile control unit 109 determines whether or not the error page setting in the setting screen 601 is set to “save”. In a case where it is set to save, transition is made to step S705, and if it is set to do not save, the processing ends.

In step S705, the facsimile control unit 109 determines whether or not the save format within the device setting within the above described setting screen 601 is set to “convert”. In a case where it is set to convert, transition is made to step S706, and in a case where it is set to not covert, transition is made to step S707. In step S706, the facsimile control unit 109 restores the transmission image in the page memory 113 into image information by the decoding module 202 and also re-encodes in accordance with the information for the save format within the device by the encoding module 204, and transitions the processing to step S707. In step S707, the facsimile control unit 109 saves the above described re-encoded transmission image or the transmission image which is not converted into the HDD (hard disk) 110, and the processing ends.

As explained above, by virtue of the first embodiment of the present invention, it becomes possible to save the transmission image that is actually transmitted itself upon the facsimile transmission within the transmitting side facsimile apparatus 100. With this, the sender can confirm at the transmitting side what kind of paper size, resolution, and transmission source recording was transmitted to the transmission destination.

### Second Embodiment

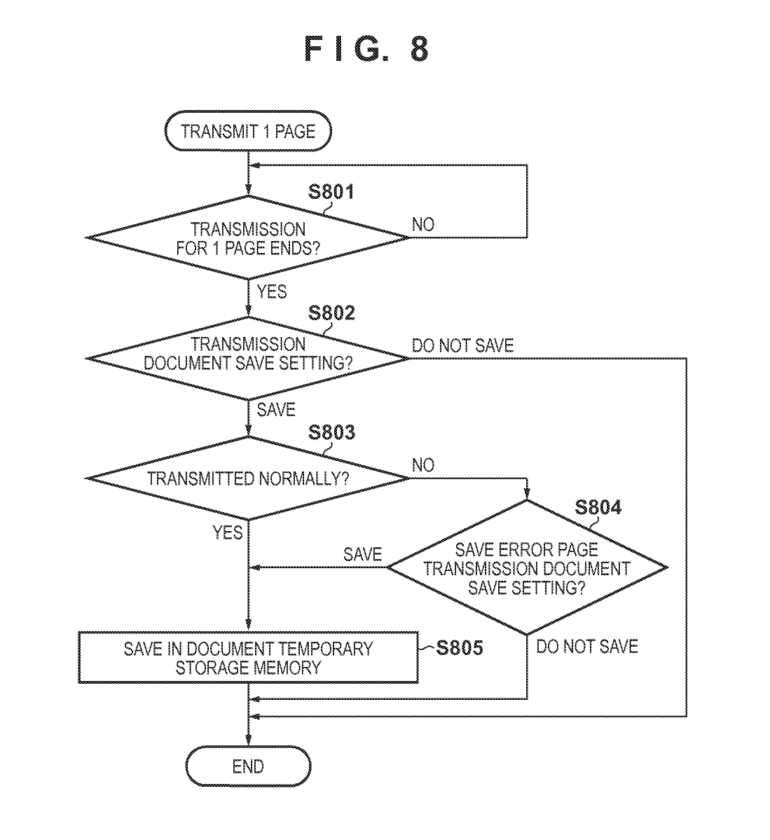

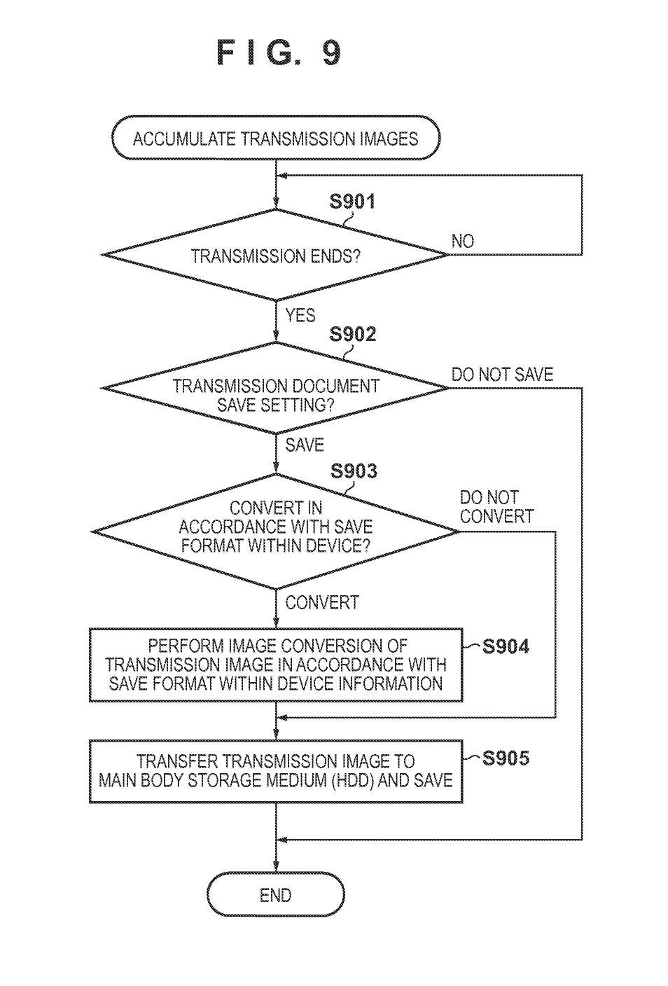

Below, with reference to FIG. 8 and FIG. 9, explanation will be given for a second embodiment of the present invention. For the second embodiment, explanation will be given for operation in which, separately from the facsimile transmission operation, the transmission image of which the facsimile transmission is actually performed is saved in the transmission source facsimile apparatus in the facsimile transmission.

Because, in a case where the transmission image is saved during the facsimile transmission, processing of the encoding decoding apparatus 104, which is used in the facsimile transmission, and processing of the encoding decoding apparatus 104 which is used upon a transmission image save operate in parallel, it can be considered that image generation will be delayed and that will result in communication errors. So, by making different the timing at which the transmission image is saved, a facsimile apparatus, capable of saving the transmission image, that inhibits the occurrence of communication errors is provided.

<Transmission Processing Procedure>

Firstly, with reference to FIG. 8, explanation will be given for details of a transmission processing procedure in the second embodiment. Note, the processing explained below is realized by the CPU of the system control unit 108 executing a control program stored in a memory.

Upon a facsimile transmission, in step S801, the facsimile control unit 109, which operates by the CPU within the system control unit 108, determines whether the transmission of the transmission image for one page ends at the timing of step S509 of FIG. 5. Regarding the above described completion of the transmission image for one page, the transmission of one page is determined to have ended when, in response to a PPS-EOP, PPS-EOM, or PPS-MPS, or a EOP, EOM, or MPS facsimile procedure signal transmitted from the transmitting side facsimile apparatus, an MCF, RTP, or RTN is received. Also, upon reception of a DCN, which is a disconnection signal from the receiving side, or in a case where there is no notification of the facsimile procedure signal within a predetermined period from the receiving side, it is determined that the transmission of the page ended in an error. When it is determined that the transmission of the page ends, transition is made to step S802. If not, the determination of step S801 is repeated at regular intervals.

Next, in step S802, the facsimile control unit 109 acquires information that the user sets via the setting screen 601 from the RAM unit within the system memory 106. In a case where the setting of the above described setting screen 601 is the “save” setting, transition is made to step S803. In a case where the setting is “do not save”, the processing ends.

In a case where the transmission document is saved, the facsimile control unit 109, in step S803, determines whether or not the page is transmitted normally. In a case where it is transmitted normally, transition is made to step S805, and if not, transition be made to step S804. More specifically, in a case where, in step S509 described above, an MCF signal is received, it is determined that yes, the page is transmitted normally, and transition is made to step S805. In a case other than the MCF signal, transition is made to step S804. In step S804, the facsimile control unit 109 determines whether or not the error page setting in the setting screen 601 is set to “save”. In a case where it is set to save, transition is made to step S805, and if it is set to do not save, the processing ends.

In step S805, the facsimile control unit 109 copies the transmission image for one page, which is stored in the page memory 113, into the document temporary storage memory 114. The above described copy operation is executed for each page. By executing for all of the transmission pages, the transmission images for all of the pages are saved in the document temporary storage memory 114 when facsimile transmission ends.

<Save Processing Procedure>

Next, with reference to FIG. 9, explanation will be given for a save processing procedure performed after facsimile transmission ends in the second embodiment. Note, the processing explained below is realized by the CPU of the system control unit 108 executing a control program stored in a memory.

In step S901, the facsimile control unit 109 determines whether or not the facsimile transmission operation has ended for all pages. If the transmission operation has ended, transition is made to step S902. If not, the determination of step S901 is repeated at regular intervals.

In step S902, the facsimile control unit 109 determines whether or not the transmission document is saved by acquiring the user setting information for the setting screen 601 from the RAM unit within the system memory 106. In a case where the above described setting of the setting screen 601 is set to “save”, transition is made to step S903, and in a case where it is set to “do not save”, the processing ends.

In step S903, the facsimile control unit 109 determines whether or not the save format within the device setting within the setting screen 601 is set to “convert”. In a case where it is set to “convert”, transition is made to step S904, and in a case where it is set to “do not convert”, transition is made to step S905. In step S904, the facsimile control unit 109 restores the transmission image in the document temporary storage memory 114 into image information by the decoding module 202 and also re-encodes in accordance with the information for the save format within the device by the encoding module 204, and transitions the processing to step S905. In step S905, the facsimile control unit 109 saves the above described re-encoded transmission image or the transmission image for which image conversion is not performed into the HDD (hard disk) 110, and the processing ends.

As explained above, by virtue of the second embodiment, the transmission image can be saved without a communication error occurring by making the timing at which the transmission image is saved to be after the transmission ends. Also, in the second embodiment, whether to save/not save is designatable by a user mode setting even for an error page, for a setting for saving a transmission image, of which a facsimile transmission is performed, into the HDD 110 within the transmission source facsimile apparatus. Also, whether to convert to the save format within the device and then save or not is designatable. Furthermore, configuration may be taken in which it is possible to register whether to save/not save to a destination table, and only to save for when transmitting to a particular destination. Also, configuration may be taken such that, in the image conversion module 201, saving is only performed when a resolution modification for which image degradation will occur or when a paper size conversion for which an image reduction will occur is performed. Also, the save destination for the transmission image is not limited to the transmitting side facsimile apparatus, and configuration may be taken such that it is saved to a server, a storage, or the like, on a network.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like. While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-260662 filed on Dec. 17, 2013, which is hereby incorporated by reference herein in its entirety.

What is claimed is:

1. A facsimile apparatus comprising:
a reading unit configured to read an original;
an image processing unit configured to execute image processing on image data of the original read by the reading unit in accordance with a capability of a partner apparatus to which the image data is transmitted;
a transmission unit configured to transmit the image data for which the image processing is executed by the image processing unit to the partner apparatus as transmission data; and
a save unit configured to save, to a storage unit, the transmission data, transmitted by the transmission unit, as is.

2. The facsimile apparatus according to claim 1,
further comprising a setting unit configured to set whether or not to save the transmission data as is, wherein
the save unit,
in a case where it is set to save the transmission data by the setting unit, saves, to the storage unit, the transmission data, and in a case where it is not set to save the transmission data by the setting unit, does not save, to the storage unit, the transmission data.

3. The facsimile apparatus according to claim 2, wherein
the setting unit further sets whether or not to save error data for a case where the transmission of the transmission data by the transmission unit cannot be performed normally, and
the save unit,
in a case where it is set to save the error data by the setting unit, saves, to the storage unit, the error data, and in a case where it is not set to save the error data by the setting unit, does not save, to the storage unit, the error data.

4. The facsimile apparatus according to claim 2, wherein
the setting unit further sets whether or not to convert to a save format of the facsimile apparatus for a case where data is saved, and
the save unit,
in a case where it is set to convert to the save format of the facsimile apparatus by the setting unit, converts the data to be saved into the save format and saves, to the storage unit, the converted data, and in a case where it is not set to convert to the save format of the facsimile apparatus by the setting unit, saves, to the storage unit, without converting the data to be saved into the save format, the data to be saved.

5. The facsimile apparatus according to claim 1, wherein the save unit, for each page in the transmission data, saves, to the storage unit, data at a timing at which transmission for a respective page by the transmission unit ends.

6. The facsimile apparatus according to claim 1, wherein the save unit saves, to the storage unit, data at a timing at which transmission of all pages in the transmission data by the transmission unit has ended.

7. The facsimile apparatus according to claim 6, wherein the save unit, for each page in the transmission data, saves the transmission data into a temporary storage unit, capable of saving at a higher speed than the storage unit, at a timing at which a transmission for a respective page by the transmission unit ends, and the save unit saves, to the storage unit, data at a timing at which transmission of all pages in the transmission data by the transmission unit has ended using the transmission data which is saved to the temporary storage unit.

8. The facsimile apparatus according to claim 1,
further comprising an acquisition unit configured to acquire capability information of the partner apparatus, wherein
the image processing unit executes image processing for the image data in accordance with the capability information acquired by the acquisition unit.

9. The facsimile apparatus according to claim 8, wherein the capability information includes at least one of a paper size printable by the partner apparatus, a resolution printable by the partner apparatus and an image data encoding scheme processable by the partner apparatus.

10. A method of controlling a facsimile apparatus, the method comprising:
reading an original;
executing image processing on image data of the original read in the reading in accordance with a capability of a partner apparatus to which the image data is transmitted;
transmitting the image data for which the image processing is executed in the executing to the partner apparatus as transmission data; and
saving, to a storage unit, the transmission data, transmitted in the transmitting, as is.

11. A non-transitory computer-readable storage medium storing a program for causing a computer to function as the facsimile apparatus of claim 1.
